(19) United States
(12) Patent Application Publication
(10) Pub. No.: US 2007/0131821 A1
(43) Pub. Date: Jun. 14, 2007

(54) Wing/winglet configuration and aircraft including it

(75) Inventor: Zdenek Johan, Garches (FR)

Correspondence Address: STEVENS, DAVIS, MILLER & MOSHER, LLP, 1615 L. STREET, NW SUITE 850, WASHINGTON, DC, 20036, US

(73) Assignee: DASSAULT AVIATION, Paris (FR)

(21) Appl. No.: 11/635,616

(22) Filed: Dec. 8, 2006

Related U.S. Application Data
(60) Provisional application No. 60/749,064, filed on Dec. 12, 2005.

(51) Int. Cl. B64C 5/06

(52) U.S. Cl. 244/91

(57) ABSTRACT

A wing/winglet configuration includes an airfoil and a winglet disposed at one end of said airfoil, said airfoil and said winglet defining an airfoil zone, a winglet zone and a connecting zone of connection of the winglet and the airfoil, a portion of the upper surface of the profile being flattened, in at least one part of said connecting zone, relative to the same portion of the upper surface of the profile of the airfoil zone, said flattened portion in at least one part of said connecting zone being a central portion of the upper surface of the profile. The invention relates also to an aircraft including such a wing/winglet configuration.

### BACKGROUND OF THE INVENTION

1. Field of the Invention

The invention relates to a wing/winglet configuration, in particular for aircraft, and to an aircraft including such a wing/winglet configuration.

2. Description of the Prior Art

It is known to provide an aircraft wing with a winglet disposed at one end of the airfoil in order to reduce the drag of the aircraft.

The airfoil and the winglet respectively define an airfoil zone and a winglet zone that are linked by a zone of connection of the winglet and of the airfoil.

Conventionally, the profiles of the airfoil zone feature a convex and domed upper surface whereas their lower surface includes a convex first portion extending from the leading edge and a concave second portion extending to the trailing edge.

Conventionally, the profiles of the winglet zone also feature a convex and domed upper surface, whereas their lower surface includes a convex first portion extending from the leading edge and a concave second portion extending to the trailing edge.

However, it is known that the zone of connection of the winglet and of the airfoil of this type of wing generates a “corner” flow between the airfoil and the winglet, which is unfavorable from the point of view of the drag.

Thus the document U.S. Pat. No. 5,275,358, hereinafter Goldhammer patent, describes an example of an aerodynamic profile of a wing/winglet configuration intended for an aircraft. According to the Goldhammer patent, the rear portion of the upper surface of the profiles of the airfoil and of the winglet is flattened up to the trailing edge in the zone of connection of the airfoil and of the winglet. More precisely, according to the Goldhammer patent, this flattening is produced for the points of the upper surface corresponding to the portion situated at a chord percentage from 40% to 100%, the chord percentage being measured from the leading edge.

However, it has been found that such a flattening in accordance with the Goldhammer patent enables a reduction of the drag to be ensured only in certain flight modes of an aircraft, and that it produces no improvement if not a deterioration of the drag in other flight modes, in particular in transonic cruising mode.

In fact there has been observed in certain cases an excess consumption of the aircraft equipped with such a wing/winglet configuration, above all when the latter is flying in a transonic cruising mode.

One object of the invention is therefore to propose a wing/winglet configuration not featuring the drawbacks mentioned above and enabling, in particular, correct functioning of the winglet to be ensured in transonic cruising mode of the aircraft, avoiding in particular the risks of excess fuel consumption.

### SUMMARY OF THE INVENTION

This object of the invention is achieved by means of a wing/winglet configuration including an airfoil and a winglet disposed at one end of said airfoil, said airfoil and said winglet defining an airfoil zone, a winglet zone and a connecting zone of connection of the winglet and of the airfoil, a portion of the upper surface of the profile being flattened, in at least one part of said connecting zone, relative to the same portion of the upper surface of the profile of the airfoil zone, wherein said flattened portion in at least one part of said connecting zone is a central portion of the upper surface of the profile.

In fact, there has been observed a significant reduction in the drag of the wing according to the invention, in particular in transonic cruising mode. Now this drag which increases very strongly with the speed in the vicinity of transonic modes is a factor in excess fuel consumption by the aircraft. The wing according to the invention therefore enables the consumption of the aircraft to be reduced and consequently its range to be increased.

Surprisingly, it has become apparent that the flattening of the profile of the wing in the connecting zone, in its central portion in accordance with the invention, enables the shockwaves to be significantly reduced in the connecting-zone without risk of creating separation of the airflow propagating along the lower surface, in contrast to the wing described in the Goldhammer patent.

The wing/winglet configuration according to the invention preferably features one or more of the following features separately or in combination:

said connecting zone includes a nominal profile in which the flattening of the upper surface of the profile of said at least one portion of said connecting zone has a maximum;

said nominal profile is situated in the vicinity of the chord plane forming a dihedral angle equal to the average of the dihedral angles of the winglet zone and of the airfoil zone;

the flattened portion of the upper surface of the nominal profile of said connecting zone begins at a chord percentage from the leading edge from 15% to 35%;

the flattened portion of the upper surface of the nominal profile of said connecting zone begins at a chord percentage from the leading edge substantially equal to 25%;

the flattened portion of the upper surface of the nominal profile of said connecting zone ends at a chord percentage from the leading edge from 55% to 75%;

the flattened portion of the upper surface of the nominal profile of said connecting zone ends at a chord percentage from the leading edge substantially equal to 65%;

the upper surface of the nominal profile of said connecting zone has a maximum radius of curvature in the vicinity of the master torque point of said wing;

the maximum radius of curvature of the upper surface of the nominal profile of said connecting zone is from five times to twenty times the maximum radius of curvature of the upper surface of the profile of said airfoil zone; and

the maximum radius of curvature of the upper surface of the nominal profile of said connecting zone is ten times greater than the maximum radius of curvature of the upper surface of the profile of the airfoil zone.

The invention relates also to an aircraft including a wing/winglet configuration as described hereinabove in all its combinations.

Other advantages and features of the invention will become apparent on examining the description of the preferred embodiment of the invention that follows, offered by way of nonlimiting example only, with reference to the appended figures.

### BRIEF DESCRIPTION OF THE DRAWINGS

FIG. 1 represents in perspective a stationary aircraft provided with wing/winglet configurations according to the invention.

FIGS. 2 and 3 represent a detail of the wing/winglet configuration according to the invention, respectively in perspective and seen in lateral elevation.

FIG. 4 represents a profile of the airfoil zone and the nominal profile of the connecting zone of the wing according to the invention.

FIG. 5 represents the upper surface of the profiles of the wing represented in FIG. 3.

FIG. 6 represents the variation of the radius of curvature of the upper surfaces represented in FIG. 5.

### DETAILED DESCRIPTION OF THE PREFERRED EMBODIMENT

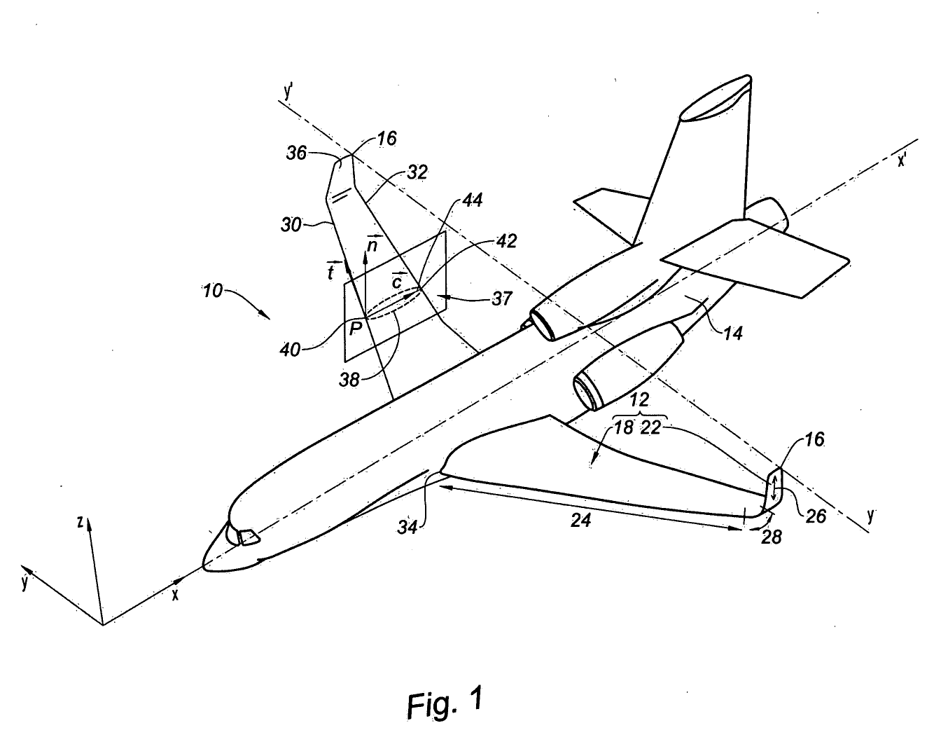

FIG. 1 is referred to here, in which is represented a stationary aircraft 10 on which are mounted two wing 12/winglet configurations according to the invention.

The axis X-X′ is defined as being the median axis of the fuselage 14 of the aircraft 10 and the axis Y-Y′ as being the axis joining the end points 16 of each of the two wings 12.

The direct orthogonal system of axes ( x̅, y̅, z̅) is then defined in which:

the vector x̅ is a director vector of the axis X-X′ oriented in the direction of the rear of the aircraft 10;

the vector y̅ is a director vector of an axis parallel to the axis Y-Y′ determined in such a manner that the system of axes ( x̅, y̅, z̅) is effectively a direct orthogonal system of axes; and

the vector z is perpendicular to the plane defined by the vectors x̅ and y̅, oriented toward the top of the aircraft 10.

A wing 12/winglet configuration according to the invention includes an airfoil 18 and a winglet 22 that define an airfoil zone 24, a winglet zone 26 and a zone 28 of connection of the winglet and of the airfoil.

The wing 12/winglet configuration also features, in known manner, a leading edge line 30 and a trailing edge line 32.

At each point P of the leading edge line 30, traveled from its end 34 attached to the fuselage 14 of the aircraft 10 to its free end 36, a vector t̅ is defined tangential to the leading edge line 30.

There is then defined, at each point P of the leading edge line 30, a vector n normal to the plane (P, x̅, t̅) defined by the point P and the vectors x̅ and t̅, in such a manner that the system of axes ( x̅, t̅, n̅) is a direct system of axes.

For each point P of the leading edge line 30, what is called the chord plane 37 is the plane (P, x̅, n̅) defined by the point P and the vectors x̅ and n̅.

The profile 38 of the wing 12 at the point P (also called the lift-producing profile or section) is defined as being the intersection of the chord plane 37 (P, x̅, n̅) with the wing 12.

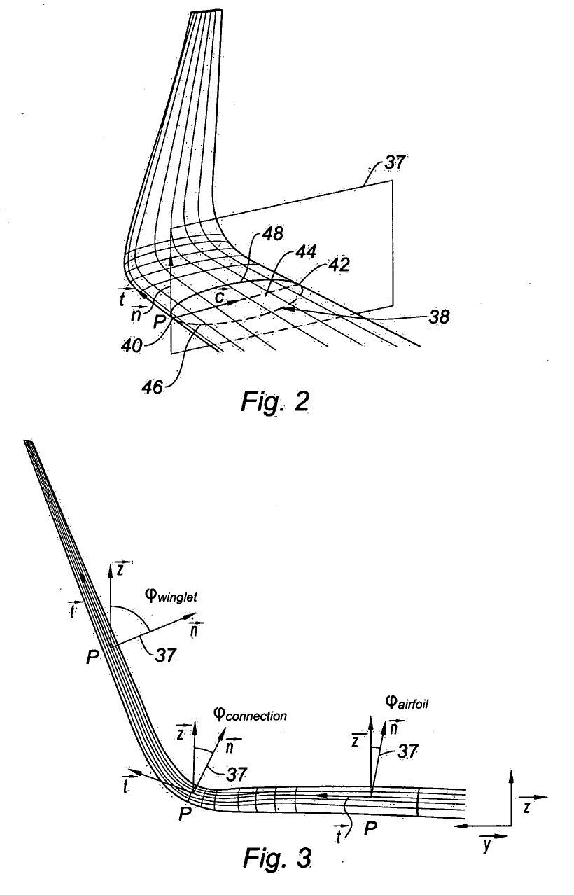

As is represented in FIG. 2, the profile 38 includes a leading edge 40 (which corresponds in fact to the point P considered) and a trailing edge 42. The segment joining the leading edge 40 and the trailing edge 42 is called the chord 44. There is defined a vector c, director vector of the chord 44 oriented from the leading edge 40 toward the trailing edge 42 (see c̅_{V} and c̅_{N}, FIG. 5).

What is called the lower surface 46 of, the profile 38 is the portion of the profile 38 situated below the chord 44, that is to say the portion of the profile 38 oriented toward the bottom of the wing 12 or on the side opposite to the vector n̅.

The upper surface 48 of the profile 38 is defined as being the portion of the profile 38 situated above the chord 44, that is to say the portion of the profile 38 oriented toward the top of the wing 12 or on the same side as the vector n̅.

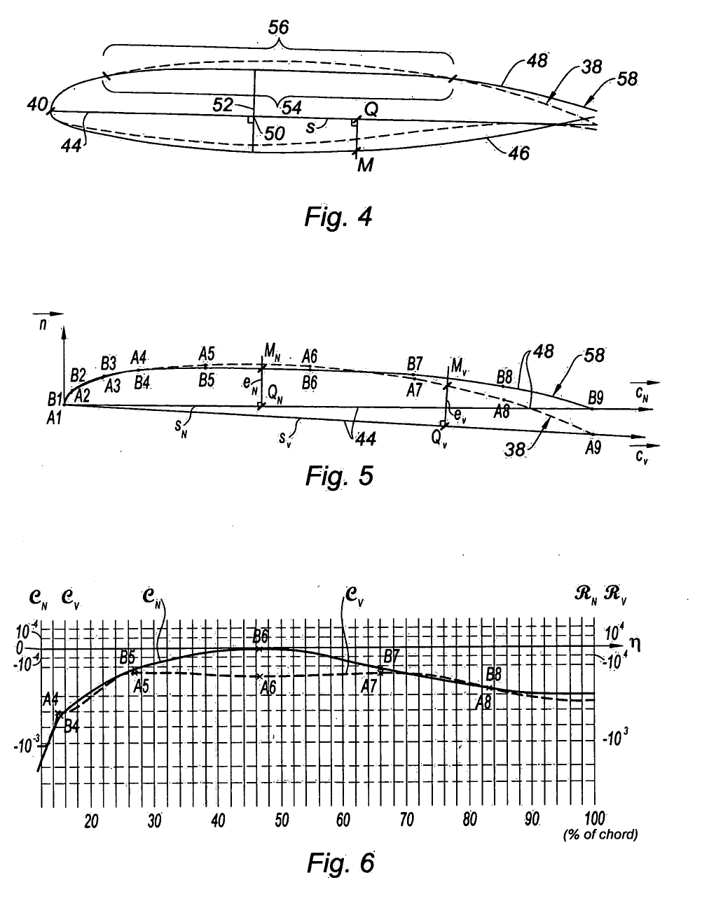

As indicated in FIG. 4, a point M of the lower surface 46 or of the upper surface 48 of a profile 38 may be identified uniquely by its orthogonal projection Q onto the chord 44, that is to say by the distance s between this projection Q and the leading edge 40, called the abscissa hereinafter and measured from the leading edge 40. The point M may be further identified by means of the relative position of its projection onto the chord denoted n and given by the equation:

$$η ( M ) = \frac{s ( M )}{I} \times 100 \qquad ( E1 )$$

in which s(M) represents the abscissa of the point M as just defined, and in which l represents the length of the chord 44 of the profile 38 considered. This relative position is therefore measured from the leading edge 40 and is expressed as a chord percentage.

Moreover, the master torque point 50 is defined as being the point of the chord 44 at which the thickness 52 of the profile 38 is a maximum.

FIG. 3 is referred to from now on, in which there has been represented a detail of the wing 12/winglet configuration according to the invention, seen in lateral elevation.

What is called the dihedral angle at the point P, P being a point of the leading edge line, is the angle φ formed, in the plane (P, y̅, z̅), by the chord plane 37 at the point P, (P, x̅, n̅), with the plane (P, x̅, z̅).

The airfoil zone 24 is defined as being the zone of the ring 12 at which the chord planes 37 at the points P of the leading edge line of the airfoil form with the plane (P, x̅, z̅), in the plane (P, y̅, z̅), a constant angle φ_{airfoil}. In other words, the dihedral angle is constant for all of the points P of the leading edge line of the wing in the airfoil zone 24.

The winglet zone 26 is defined as being the zone of the winglet 22 in which the chord planes 37 at the points P of the leading edge line of the winglet 22 form with the plane (P, x̅, z̅), in the plane (P, y̅, z̅), a constant angle φ_{winglet}. Thus, the dihedral angle is constant for all of the points P of the leading edge line of the wing in the winglet zone 26.

The connecting zone 28 is remarkable in that the chord planes 37 at the points P of the leading edge line of the connecting zone 28 form, in the plane (P, y̅, z̅), with the plane (P, x̅, z̅), a variable angle φ_{connection}, this angle φ_{connection} varying continuously and in a derivable manner along the leading edge line 30, from the value φ_{airfoil} at the boundary between the connecting zone 28 and the airfoil zone 24, to the value φ_{winglet} at the boundary between the connecting zone 28 and the winglet zone 26. In other words, the dihedral angle varies, in the connecting zone 28, continuously and in a derivable manner from the value of the dihedral angle in the airfoil zone 24 at the boundary between the connecting zone 28 and the airfoil zone 24, to the value of the dihedral angle in the winglet zone 26 at the boundary between the connecting zone 28 and the winglet zone 26.

Remarkably, as represented in FIG. 4 for the nominal profile, in at least one part of the connecting zone 28 of the wing 12 according to the invention, only a central portion 54 of the upper surface 48 of the profile 38 is flattened relative to the same portion 56 of the upper surface 48 of the profile 38 of the airfoil zone 24. Thus, in contrast to the Goldhammer patent in which the flattening of the upper surface of the profile of the connecting zone is produced in a rear portion, that is to say situated in the vicinity of and extending as far as the trailing edge of the wing, here, the flattening of the upper surface of the profile in the connecting zone is produced in a central portion only, the portion of the upper surface adjacent to the trailing edge having a curvature substantially equivalent to that of the upper surface of the profile of the airfoil zone in the same portion of the chord.

The flattening, in its central portion, of the profile of the wing in at least one part of the connecting zone enables, in particular in the transonic cruising mode, avoidance or minimization of the drag, which is a source of excess consumption of fuel by the aircraft.

This result may be attributed to the fact that, the flattening, in its central portion, of the profile of the wing in the winglet zone enables a significant reduction of the shockwaves in the connecting zone without risk of creating separation of the airflow propagating along the lower surface.

In fact, a small variation of the speed in transonic mode may occasion a brutal increase in the drag of the wing caused by the increase of the force of the shockwaves of the airflow over the surface of the wing, in particular in the connecting zone. There may even occur in certain cases a separation of the boundary layer of the airflow, which increases the drag of the wing all the more. In this case, the winglet of the wing has no effect. Of course, this increase of the drag is reflected in an increase in the consumption of the aircraft.

With the flattening of the central portion of the profile of a part of the connecting zone, the wing/winglet configuration according to the invention is further enabled to be less sensitive to these small fluctuations in the speeds of flow of the airflow and thus to obtain the effect of the winglet of the wing even in the case of a slight increase in the speed of the airflow in the transonic cruising mode of the aircraft.

In this instance, the profile 38 of the airfoil zone 24 is substantially identical over the whole of the airfoil zone 24.

Thus the whole of the connecting zone 28 of the wing 12 according to the invention preferably has a profile 38 the upper surface whereof includes a central portion 54 flattened relative to the same portion 56 of the upper surface 48 of the profile 38 of the airfoil zone 24, as is represented in FIG. 4. In that FIG. 4, the profiles 38, 58 have been expanded by a coefficient of two in their respective directions n̅.

More precisely, here, the connecting zone 28 includes a nominal profile 58 in which the flattening of the upper surface 48 of the profile 38 of the connecting zone 28 features a maximum, the profile 38 of the wing 12 in the connecting zone 28 varying in a two-fold continuous and derivable manner over the whole of the connecting zone 28.

This therefore ensures a smoothing of the upper surface 48 of the connecting zone 28 that enables avoidance of the disturbances compromising the flow of air in the vicinity of the wing 12/winglet configuration according to the invention.

The nominal plane corresponds here to the chord plane forming a dihedral angle φ_{N} equal to the average of the dihedral angle of the airfoil zone φ_{airfoil} and of the dihedral angle of the winglet zone φ_{winglet}:
φ_{N}=½(φ_{airfoil}+φ_{winglet}) (E2)

FIG. 4 is referred to from now on in which there has been represented in the same plane, in continuous line, the nominal profile 58 of the connecting zone 28 and, in dashed line, the profile 38 of the airfoil zone 24.

Comparing the two profiles 38, 58 shows in particular that the portion 54 of the upper surface 48 of the nominal profile 58 of the connecting zone 28 is flattened relative to this same portion 56 of the upper surface 48 of the profile 38 in the airfoil zone 24. The portion of each profile corresponds to a portion of the chord 44, that is to say, for example, to a chord percentage range that defines the relative position of the points of the portion of the profile.

However, as represented in FIG. 4, the front portion (that is to say the portion adjacent to the leading edge) and the rear portion (that is to say the portion adjacent to the trailing edge) of the upper surface of the nominal profile of the connecting zone preferably feature a curvature substantially analogous to that of the upper surface of the profile of the airfoil zone.

The upper surfaces of the two profiles 38, 58 from FIG. 4 are described and compared in more detail hereinafter with reference to FIGS. 5 and 6.

In FIG. 5, the upper surface 48 of the nominal profile 58 of the connecting zone and of the profile 38 of the airfoil zone 24 are represented in the same figure with the respective leading edges 42 of the two profiles 38, 58 made to correspond, the profile 38 of the airfoil zone 24 having been pivoted slightly relative to its leading edge, in such a manner as to make the direction of the respective normal vectors n̅ of the two profiles correspond.

Thus the upper surface 48 of the nominal profile 58 of the connecting zone may be described as a function e_{N} that associates with a point Q_{N} of the chord 44 of the nominal profile 58, identified by its abscissa s_{N}, the distance e_{N}(s_{N}) between the point Q_{N} of the chord 44 considered and the point M_{N} of the upper surface 48 of the nominal profile 58 situated at the level of the point Q_{N} of the chord 44 considered.

Similarly, the upper surface 48 of the profile 38 of the airfoil zone 24 may be described as a function e_{V} that associates with a point Q_{V} of the chord 44 of the profile 38, identified by its abscissa s_{V}, the distance e_{V}(s_{V}) between the point Q_{V} of the chord 44 considered and the point M_{V} of the upper surface 48 of the profile 38 situated at the level of the point Q_{V} of the chord 44 considered.

The functions e_{N} and e_{V} are in a two-fold continuous manner derivable along the chord in such a manner as to ensure a stable flow that is as little disturbed as possible of the air along the upper surface 48 of the wing 12. In fact, the continuity of the curvature along the upper surface of the profiles considered is thus ensured.

In FIG. 5, in which only the upper surfaces 48 of the two profiles from FIG. 4 are represented, points A1 to A9 and B1 to B9 are indicated respectively on the upper surface 48 of the nominal profile 58 of the connecting zone 28 and on the upper surface 48 of the profile 38 of the airfoil zone 24, the points with the same index corresponding to a same relative position on the respective chord of the two profiles considered.

Thus the upper surface 48 of the profile 38 of the airfoil zone 24 being describable with the aid of the function e_{V} of s_{V}, the curvature C_{V} and the radius of curvature R_{V} of the upper surface at a point Aᵢ, identified by its abscissa s_{Ai} are defined by the equations:

$$\begin{matrix}{C}_{V} ( {A}_{i} ) = \frac{{d}^{2} {e}_{V}}{{ds}_{V}^{2}} ( {s}_{Ai} ) & ( E3 ) \\ {R}_{V} ( {A}_{i} ) = \frac{1}{{C}_{V} ( {A}_{i} )} & ( E4 )\end{matrix}$$

Similarly, the upper surface 48 of the nominal profile 58 of the connecting zone being describable with the aid of the function e_{N} of x_{N}, the curvature C_{N} and the radius of curvature R_{N} of the upper surface at a point Bᵢ, identified by its abscissa S_{Bi}, are defined by the equations:

$$\begin{matrix}{C}_{N} ( {B}_{i} ) = \frac{{d}^{2} {e}_{N}}{{ds}_{N}^{2}} ( {s}_{Bi} ) & ( E5 ) \\ {R}_{N} ( {B}_{i} ) = \frac{1}{{C}_{N} ( {B}_{i} )} & ( E6 )\end{matrix}$$

In this instance, the curvatures C_{V} and C_{N} of the upper surface of the nominal profiles of the connecting zone and of the airfoil zone are magnitudes expressed in m⁻¹, the radii of curvature R_{V} and R_{N} being as for them expressed in m.

In such a manner as to be entirely representative, these radii of curvature R_{V} and R_{N} must be considered as referred to the lengths l_{V}, l_{N} of the chord of their respective profile.

Thus there is defined for each radius of curvature R_{V} and R_{N} a relative radius of curvature [symbol] _{V} and [symbol] _{N}:

$$\begin{matrix}{R}_{V} ( {B}_{i} ) = \frac{{R}_{V} ( {B}_{i} )}{{I}_{V}} \\ and by & ( E7 ) \\ {R}_{N} ( {A}_{i} ) = \frac{{R}_{N} ( {A}_{i} )}{{I}_{N}} & ( E8 )\end{matrix}$$

where:

l_{V} represents the length of the chord of the profile of the airfoil zone considered, and

l_{N} represents the length of the chord of the nominal profile of the connecting zone.

In FIG. 6, there have been represented the variations of the relative radius of curvature of the upper surface of the two profiles represented in FIG. 4 as a function of the relative position relative to the chord of each of the profiles. The relative radius of curvature of the nominal profile of the connecting zone is represented in continuous line whereas the relative radius of curvature of the profile of the airfoil zone is represented in dashed line.

Notice in this FIG. 6 that the relative radius of curvature of the upper surface of the two profiles is always negative along the chord, since the upper surface of the two profiles is convex.

Moreover, the relative radii of curvature of the nominal profile of the connecting zone and of the profile of the airfoil zone are preferably substantially identical for chord percentages from 0 to 27%, that is to say adjacent to their respective leading edge. In this portion of the profile, the two relative radii of curvature increase simultaneously.

Then, for chord percentages from 27% to 68%, that is to say in the central portion of the chord, the relative radius of curvature of the nominal profile of the connecting zone is greater, in absolute value, than the relative radius of curvature of the profile of the airfoil zone. In fact, in this portion of the chord, the relative radius of curvature of the upper surface of the profile of the airfoil zone is substantially constant, whereas the relative radius of curvature of the upper surface of the nominal profile of the connecting zone continues first to increase, passes through a maximum, reaches a chord percentage of 48% and then decreases. The relative position of the maximum relative radius of curvature corresponds substantially to that of the master torque point of the profile, that is to say the point at which the thickness of the profile is a maximum.

Thus the nominal profile of the connecting zone features a central portion flattened relative to the same central portion of the profile of the airfoil zone.

For the chord percentages from 68% to 100% the changes of the relative radius of curvature of the upper surface of the nominal profile of the connecting zone and of the profile of the airfoil zone are preferably substantially identical. In fact, in this portion of the chord, the two relative radii of curvature decrease along the chord.

There are set out in the table below the values of the relative radius of curvature. R_{V} and R_{N} of each of the two upper surfaces represented in FIG. 5 for the points with indices ranging from 4 to 9.

| | Point index | | | | | |
|---|---|---|---|---|---|---|
| | 4 | 5 | 6 | 7 | 8 | 9 |
| η | 0.15 | 0.27 | 0.46 | 0.65 | 0.82 | 1 |
| \|R_{V}\| | 1.4567 | 3.8000 | 3.2489 | 3.7318 | 2.2326 | 1.7276 |
| \|R_{N}\| | 1.3427 | 4.4425 | 55.900 | 4.2544 | 2.2206 | 1.9471 |

Thus it is seen that the maximum radius of curvature of the upper surface of the nominal profile of the connecting zone, which corresponds to the point B₆, is substantially twenty times greater than the maximum radius of curvature of the upper surface of the profile of the airfoil zone, corresponding to the point A₆.

The invention does not amount to the only example described hereinabove by way of nonlimiting example.

Thus it has been found that it was preferable that the flattened portion of the upper surface of the nominal profile of the connecting zone begins at a chord percentage from 15% to 35% and more preferably at a chord percentage substantially equal to 25%.

In fact, it has been noted that the flattened portion of the nominal profile of the connecting zone must not begin too close to the leading edge to avoid obtaining an excessively flat profile that causes an inadequate local pressure distribution along the profile. Moreover, if the beginning of the flattened portion is too far away from the leading edge, the profile does not achieve the required effect.

Moreover, the flattened portion of the upper surface of the nominal profile of the connecting zone preferably ends at a chord percentage from 55% to 75% and more preferably at a chord percentage substantially equal to 65%.

In fact, it has been noticed that if the end of the flattened portion of the nominal profile of the connecting zone is too far away from the trailing edge then the effect obtained is reduced. On the other hand, if the end of the flattened portion is too close to the trailing edge, it is then obligatory to increase the curvature of the lower surface. Now, it has been found that this increase of the lower surface caused risks of separation of the airflow along the lower surface leading to the appearance of a drag that increases the fuel consumption of the aircraft.

It is in fact necessary to retain, in the connecting zone, a downward curvature of the trailing edge sufficient to avoid separation of the flow at the lower surface of the profile and thus to have good functioning of the winglet in transonic cruising mode.

The upper surface of the nominal profile of the connecting zone preferably features a maximum radius of curvature in the vicinity of the master torque point, the maximum radius of curvature of the upper surface of the nominal profile being, moreover, at least five times greater than the maximum radius of curvature of the upper surface of the profile of the airfoil and at most twenty times greater than the maximum radius of curvature of the upper surface of the profile of the airfoil.

It has in fact been noted that too small a maximum radius of curvature of the nominal profile of the connecting zone was practically without effect, whereas too large a maximum radius of curvature of the nominal profile of the connecting zone, reflected in an excessive flattening of the upper surface of the profile of the wing, disturbed the pressure of the airflow along the upper surface and caused local pressure variations that are harmful to the good operation of the winglet according to the invention.

Under these conditions, it is apparent that a good compromise is found when the maximum radius of curvature of the upper surface of the nominal profile of the connecting zone is ten times greater than the maximum radius of curvature of the upper surface of the profile of the airfoil.

Finally, it is to be noted that the flattening of the central portion of the upper surface of the profile of the wing in the connecting zone is not incompatible with a flattening of the portion of the upper surface of the profile adjacent to the trailing edge, these two flattened portions of the upper surface of the profile being separated by a portion in which the curvature of the upper surface of the profile is analogous to the curvature of the same portion of the profile of the airfoil zone. The position of the trailing edge in the direction normal to the profiles enables adjustment of the relative curvatures of the lower surface and the upper surface of the profile in the vicinity of the trailing edge.

There is claimed:

1. A wing/winglet configuration including an airfoil and a winglet disposed at one end of said airfoil, said airfoil and said winglet defining an airfoil zone, a winglet zone and a connecting zone of connection of the winglet and of the airfoil, a portion of the upper surface of the profile being flattened, in at least one part of said connecting zone, relative to the same portion of the upper surface of the profile of the airfoil zone, wherein said flattened portion in at least one part of said connecting zone is a central portion of the upper surface of the profile.

2. The wing/winglet configuration according to claim 1, wherein said connecting zone includes a nominal profile in which the flattening of the upper surface of the profile of said at least one part of said connecting zone has a maximum.

3. The wing/winglet configuration according to claim 2, wherein said nominal profile is situated in the vicinity of the chord plane forming a dihedral angle equal to the average of the dihedral angles of the winglet zone and of the airfoil zone.

4. The wing/winglet configuration according to claim 2, wherein the flattened portion of the upper surface of the nominal profile of said connecting zone begins at a chord percentage from the leading edge from 15% to 35%.

5. The wing/winglet configuration according to claim 4, wherein the flattened portion of the upper surface of the nominal profile of said connecting zone begins at a chord percentage from the leading edge substantially equal to 25%.

6. The wing/winglet configuration according to claim 2, wherein the flattened portion of the upper surface of the nominal profile of said connecting zone ends at a chord percentage from the leading edge from 55% to 75%.

7. The wing/winglet configuration according to claim 6, wherein the flattened portion of the upper surface of the nominal profile of said connecting zone ends at a chord percentage from the leading edge substantially equal to 65%.

8. The wing/winglet configuration according to claim 2, wherein the upper surface of the nominal profile of said connecting zone features a maximum radius of curvature in the vicinity of the master torque point of said wing.

9. The wing/winglet configuration according to claim 2, wherein the maximum radius of curvature of the upper surface of the nominal profile of said connecting zone is from five times to twenty times the maximum radius of curvature of the upper surface of the profile of said airfoil zone.

10. The wing/winglet configuration according to claim 9, wherein the maximum radius of curvature of the upper surface of the nominal profile of said connecting zone is ten times greater than the maximum radius of curvature of the upper surface of the profile of the airfoil zone.

11. An aircraft including a wing/winglet configuration according to claim 1.
